(19) United States
(12) Patent Application Publication
(10) Pub. No.: US 2003/0025551 A1
(43) Pub. Date: Feb. 6, 2003

(54) Reference voltage generator

(75) Inventors: Naoki Kobayashi, Tokyo (JP); Takayuki Kawahara, Higashiyamato (JP); Takahiro Onai, Ome (JP); Hideaki Kurata, Kokubunji (JP)

Correspondence Address: Miles & Stockbridge P.C., 1751 Pinnacle Drive, Suite 500, McLean, VA, 22102-3833, US

(73) Assignee: Hitachi, Ltd.

(21) Appl. No.: 10/156,196

(22) Filed: May 29, 2002

(30) Foreign Application Priority Data
May 30, 2001 (JP) 2001-162979

(51) Int. Cl. G05F 1/10

(52) U.S. Cl. 327/540

(57) ABSTRACT

A reference voltage generator to operate under the supply voltage of 1V or less is provided. In order to output a reference voltage, the change as caused by the ambient temperature of the forward bias voltage of any one of the plural Schottky diodes is compensated with the difference in the forward bias voltage between said plural Schottky diodes. The semiconductor region corresponding to the Schottky contact interface is formed in the same process as for an N well region corresponding to the channel region of the PMOS transistor or for a P well region corresponding to the channel region of the NMOS transistor and the metallic region thereof corresponding to the Schottky contact interface is formed in the same process as for the silicide region comprising the contact region of the MOS transistor.

### FIELD OF THE INVENTION

The present invention relates to a reference voltage generator under temperature compensation, which generator is formed on a semiconductor device, and still relates to an IP core such as a systematized a LSI incorporating such reference voltage generator.

### BACKGROUND OF THE INVENTION

Nowadays, a reference voltage generator to generate a constant voltage is essential for such semiconductor products as a flash memory, a dynamic random memory (DRAM) and an analogue circuit, which voltage is used for controlling their internal voltage generators or the circuit operation thereof.

The reference voltage generator in use is required not to fluctuate its output voltage, when there occurs fluctuation in supply voltage or ambient temperature. Further, to cope with the request to lower the price of the semiconductor products in recent years, it is desirable that there is no addition of a special step for producing the reference voltage generator.

A band-gap reference voltage generator is generally used for meeting the above requirements. One example of such generator is disclosed in the Japanese Patent Application Laid-open No. H11-45125 with reference to FIGS. 21 and 22 thereof.

The output voltage of the conventional reference voltage generator amounts to approximately 1.2 V corresponding to a silicone band-gap energy, the generated supply voltage used by the conventional reference voltage generator is obliged to exceed the same voltage. However, in view of the request to operate a semiconductor product with a lower power consumption in recent years, there is tendency that a lower supply voltage is favored, which supply voltage is highly likely to become 1V or less in the future.

In turn, the above Japanese Patent Application Laid-open No. H11-45125 discloses the improved band-gap reference voltage generator, which reference voltage is generated through the counterpart supply voltage less than 1.2V.

However, as this counterpart supply voltage is constrained by the forward bias voltage V_{F} of the P-N junction diode, which V_{F} amounts to approximately 0.8V, there is a case that the system operation is interrupted under the supply voltage of 1V or less.

In view of the inconveniences encountered with the prior art, the present invention is to provide a reference voltage generator, which generator has temperature compensated function and is operable under the supply voltage of 1V or less, especially under that of 0.8V or less, without an addition of a production step for the conventional CMOS semiconductor device (hereinafter, referred to as CMOS process).

The above-described object and the other objects, and new characteristics of the present invention will be obvious from the description and the attached drawings of the specification.

### SUMMARY OF THE INVENTION

The present invention is to provide a reference voltage generator characterized in being provided with a plurality of Schottky diodes and capable of outputting a voltage affected by the change of the ambient temperature in the least degree.

The present invention is also to provide an IP core characterized in being provided with a reference voltage generator that comprises the plurality of Schottky diodes and is arranged such that the change of the forward bias voltage of any one of those diodes as caused by the ambient temperature is compensated with the difference in forward bias voltage between those plural diodes.

Further, the present invention is to provide a reference voltage generator that comprises the plurality of rectifiers and is arranged such that the change of the forward bias voltage of any one of those rectifiers as caused by the ambient temperature is compensated with the forward bias voltage of the other rectifiers, wherein the generator is capable of generating and outputting a reference voltage of 0.7V or less under the supply voltage of 1V or less.

### BRIEF DESCRIPTION OF THE DRAWINGS

Embodiments of the present invention are described below in conjunction with the figures, in which:

FIG. 1 is a view of the principle of a Schottky contact formation according the present invention;

FIGS. 2A and 2B are views of one example of a Schottky diode as prepared by the CMOS process according to the present invention;

FIG. 3 is a graph to show the relation between a doping concentration and contact resistance in a semiconductor;

FIG. 4 is a view of the Schottky Barrier Potential of silicide material;

FIGS. 5A and 5B are views of one example of a reference voltage generator according to the present invention;

FIGS. 6A and 6B are views of the temperature dependence of the voltage as output from the reference voltage generator according to the present invention;

FIGS. 7A and 7B are views of one example of a differential amplifier according to the present invention;

FIG. 8 is a view of one example of a circuit to shift the voltage level as output from the reference voltage generator according to the present invention;

FIGS. 9A and 9B are views of an example where the Schottky diode of the present invention is arranged in an N-type semiconductor substrate;

FIGS. 10A and 10B are views of an example where the Schottky diode of the present invention is arranged in an SOI-type semiconductor substrate; and

FIG. 11 is a view of one example of an LSI circuit with the reference voltage generator of the present invention incorporated therein.

### DETAILED DESCRIPTION OF THE PREFERRED EMBODIMENTS

Hereinafter, the preferred embodiments of the present invention are described in more details with reference to the accompanying drawings.

To begin with, the method for preparing a Schottky diode according to the present invention by means of COMS process is described below.

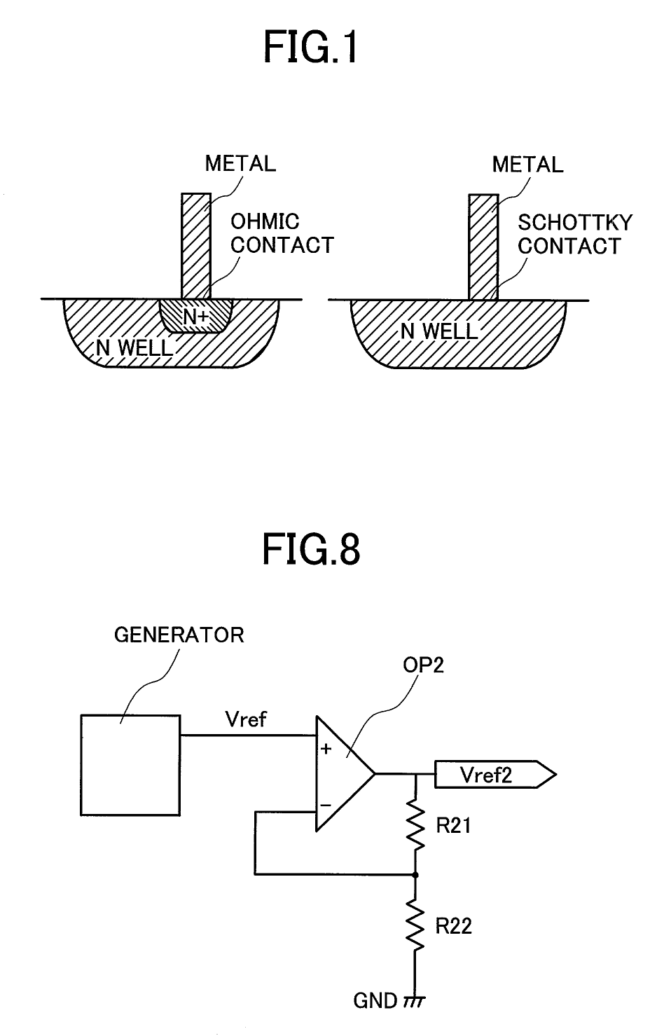

FIG. 1 shows the formation of an ohmic contact and Schottky contact upon contacting metal onto a semiconductor surface. In the drawing, a region as designated with N well is rendered an N-type semiconductor portion by adding a dopant to the substrate while a region as designated with N+ is where a dopant of higher concentration is added than the N well region.

The characteristics of an interface between the semiconductor and the metal change according to the doping concentration in the semiconductor, wherein the N+ region interfaces with the metal through the ohmic contact while the N well region interfacing therewith through the Schottky contact.

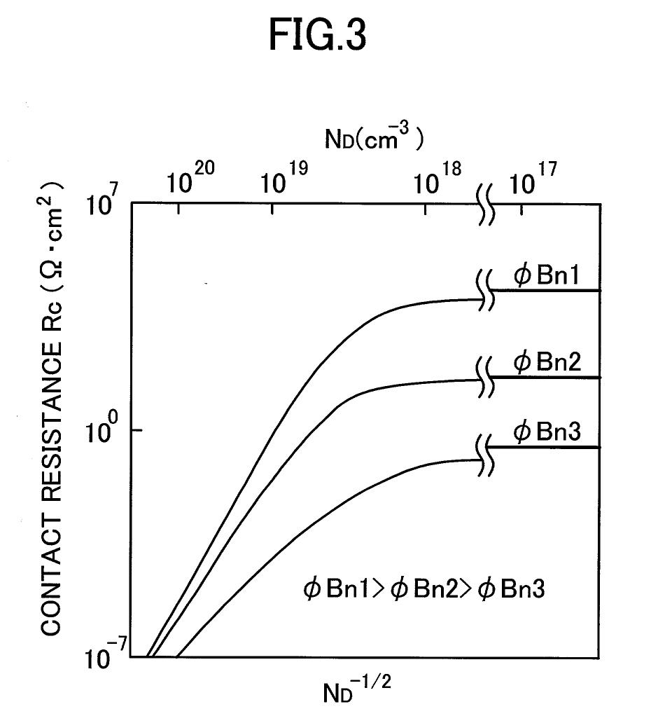

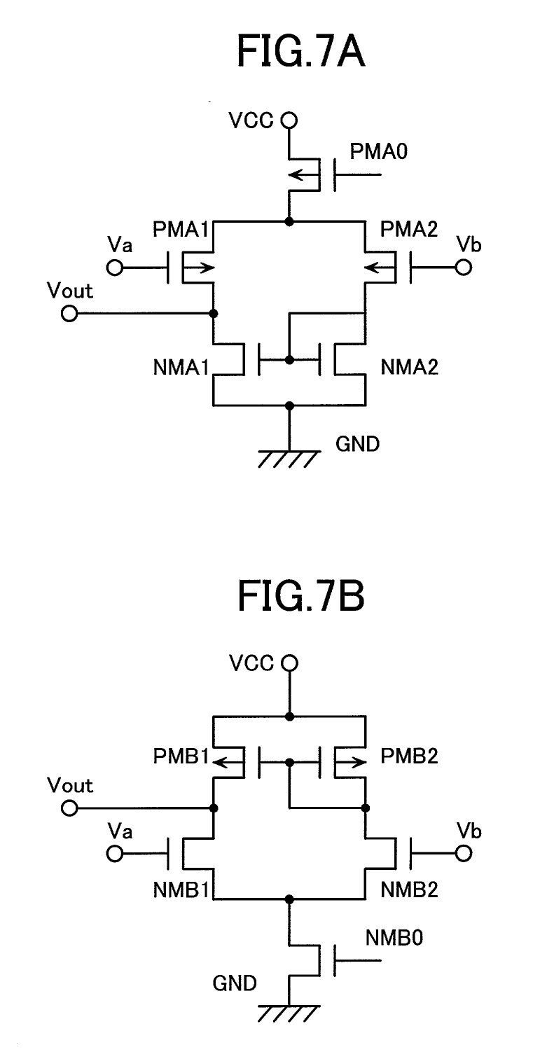

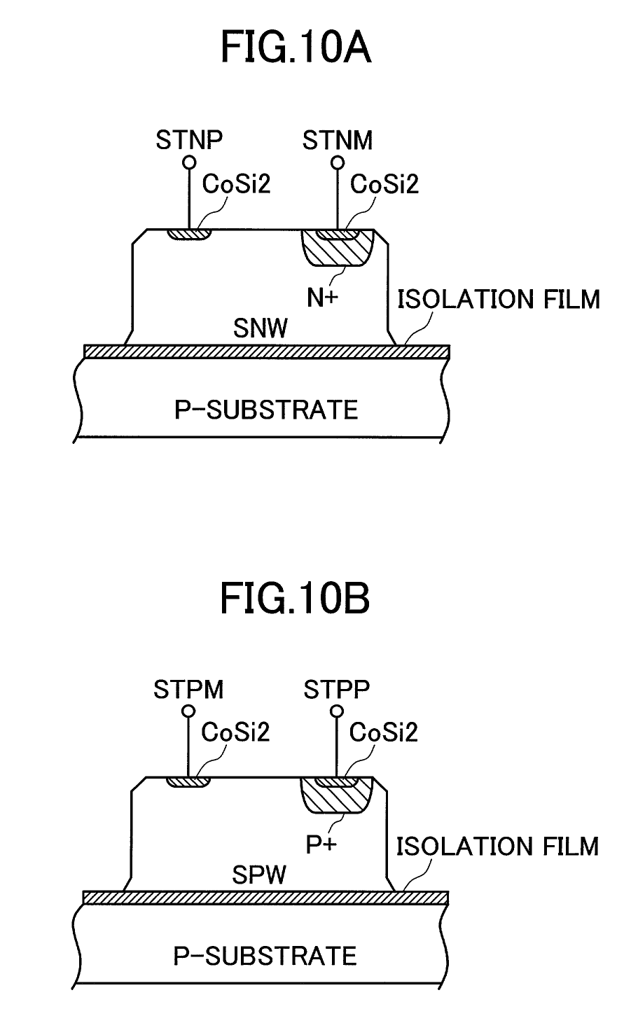

FIG. 3 is a graph to show the relation between the doping concentration and contact resistance in an N-type semiconductor, which relation is disclosed in FIGS. 7 and 10 at page 109 of ‘Physics of a semiconductor device’ written by Masatake Kishino and published on Mar. 15, 1995 from Maruzen Corporation (hereinafter, referred to as D1).

As shown in FIG. 3, it is found that where the doping concentration is in the order of 10¹⁷cm⁻³, the interface is of the Schottky contact while being of the ohmic contact where that is higher or 10¹⁹cm⁻³ or more. Also upon the contact between the P-type semiconductor with the addition of acceptor and metallic material, which case is not shown in FIG. 3, the interface between the P-type region (P well region) of lower doping F concentration and the metallic material is of the Schottky contact while that between the P-type region (P+ region) of higher doping concentration and the metallic material is being of the ohmic contact.

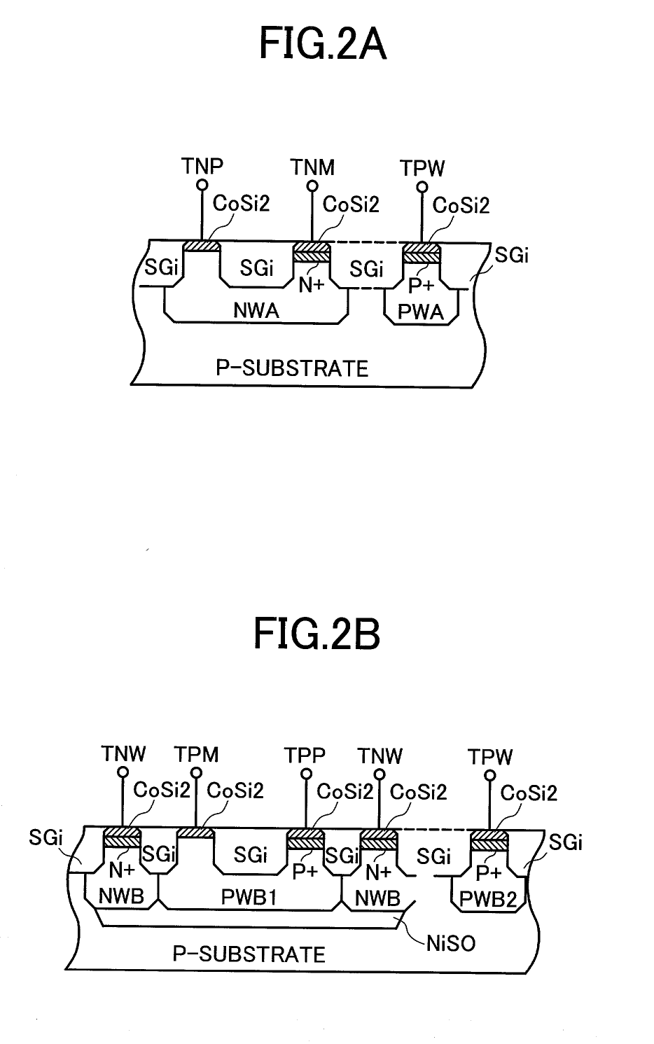

FIG. 2A and FIG. 2B show an example to produce a Schottky diode by means of the CMOS process, in which the-substrate in use is of P-type semiconductor, and NWA and NWB indicate N wells while PWA, PWB1 and PWB2 indicating P wells.

It should be noted that the N well herein is an N-type semiconductor region with a dopant added therein to an extent that the Schottky contact is formed in the interface with the metallic material and the N+ is an N-type semiconductor region with a dopant added therein to an extent that the ohmic contact is formed in the interface with the metallic material while the P well is a P-type semiconductor region with an acceptor added therein to an extent that the Schottky contact is formed in the interface with the metallic material and the P+ is a P-type semiconductor region with an acceptor added therein to an extent that the ohmic contact is formed in the interface with the metallic material.

In the CMOS process, the N well region, the N+ region, the P well region and the P+ region are formed in the step of implanting a dopant for producing a MOS transistor, any one of which regions to produce the above Schottky diode are also formed in the same step as mentioned above.

More concretely, the NWA and NWB are prepared in the same production process as for the N well constructing the channel area of the PMOS transistor while the PWA, PWB1 and PWB2 are prepared in the same production step as for the P well constructing the channel area of the NMOS transistor.

In other words, a semiconductor region constructing the Schottky contact interface of the Schottky diode is formed in the same dopant addition process as for the N well region constructing the channel region of the PMOS transistor, which transistor is formed on the same semiconductor substrate as for the Schottky diode while the semiconductor region is formed in the same acceptor addition process as for the P well region constructing the channel region of the NMOS transistor, which transistor is formed on the same semiconductor substrate as for the Schottky diode.

Further, the N+ region of the Schottky diode is formed in the same process as for N+ of the source or drain contact of the NMOS transistor while the P+ region thereof is formed in the same process as for P+ of such contact of the PMOS transistor.

NiSO in the drawing indicates an N-type semiconductor region to establish the electric potential of the P well separately from the P-type substrate while SGi therein indicating an inactive region to separate devices, both of which regions are generally formed in the CMOS process. CoSi₂ in the drawing indicates one example of metallic material for the contact formation, wherein the metallic region of the Schottky diode made from CoSi₂ that constructs the Schottky contact interface is formed in the same step as for the metallic or contact region of the MOS transistor, which transistor is formed on the same semiconductor substrate as for the Schottky diode.

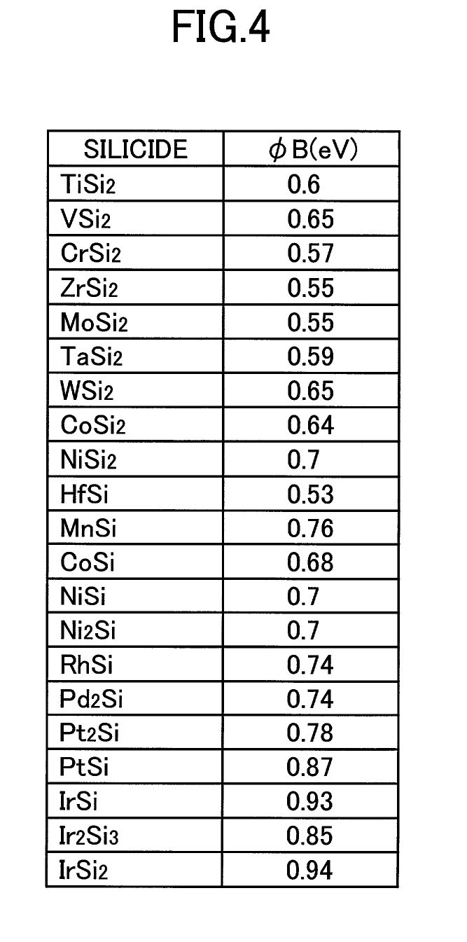

FIG. 4 is a table to show the values of the Schottky Barrier Potential ø_{BN} of CoSi₂ and other silicide materials, which materials are generally used for the formation of the ohmic contact in the CMOS process. The metallic region of the Schottky diode constructing the Schottky contact interface thereof is made from silicide material, which interface is subjected to heating treatment under high temperature for the formation of a silicide film so as to render the contact interface very pure. The values as mentioned above are hardly dependent upon the change of the ambient temperature.

As shown in FIG. 2A, a portion is formed in the N well region NWA where the NWA contacts the metallic material through the N+ region while another portion being formed therein where the NWA directly contacts the metallic material. Then, the former portion is of the ohmic contact while the latter portion is of the Schottky contact, wherein the NWA forms a Schottky diode comprising an N-type semiconductor in the interface with the metallic material. TNP and TNM in the drawing indicate a terminal as connected to the Schottky contact portion and a terminal as connected to the ohmic contact portion, respectively, wherein the electric potential of TNP corresponds to the metallic side potential of the Schottky contact while the electric potential of TNM corresponding to the semiconductor side potential thereof.

In the arrangement as shown in FIG. 2A, the electric potential of TNM is arranged higher than that of TNP for the forward bias connection of the Schottky diode. The arrangement of PWA, P+, CoSi₂ in the interface with the P+ in the drawing is intended for setting the P-type substrate at a given electric potential by applying voltage to the terminal TPW, to which terminal grounding voltage is applied, for instance.

Likewise, as shown in FIG. 2B, a portion is formed in the P well region PWB1 where the same region contacts the metallic material through the P+ region while another portion being formed therein where the PWB1 directly contacting the metallic material. The former portion is of the ohmic contact while the latter portion is of the Schottky contact, wherein the PWB1 forms a Schottky diode comprising a P-type semiconductor in the interface with the metallic material. TPM and TPP in the drawing indicate a terminal as connected to the Schottky contact portion and a terminal as connected to the ohmic contact portion, respectively, wherein the electric potential of the TPM corresponds to the metallic side potential of the Schottky contact while the electric potential of the TPP corresponding to the semiconductor side potential thereof.

In the arrangement as shown in FIG. 2B, the electric potential of the TPP is arranged higher than that of the TPM for the forward bias connection of the Schottky diode. The arrangement of PWB2, P+ and CoSi₂ in the interface with the P+ is intended for setting the P-type substrate at a given voltage by applying voltage to the terminal TPW, to which terminal grounding voltage is applied, for instance.

In order to prevent the PWB1 from being simultaneously set at the electrical potential of the P-type substrate, as shown in the drawing, NWB, N+, CoSi₂ in contact with the N+ and NiSo are arranged and higher voltage is applied to a terminal TNW than that applied to the terminal TPW so as to create a reverse bias condition against the P-N junction. VCC voltage is applied to the terminal TNW, for example, which voltage is a supply voltage as applied to the semiconductor chip from the external and may be of 0.8V or less, for instance, according to the present invention.

By the way, the Schottky diode embodied in the present invention is not necessarily limited to that as prepared by the above CMOS process, but it is of course that the same diode may be formed by a process with an N-type semiconductor substrate in use, a process with an SOI substrate in use or a process for producing a flash memory provided with a floating gate, for instances.

The process for producing the flash memory is characterized in that the memory cell thereof is formed on any one of the above P-type and N-type semiconductors as well as the SOI substrate.

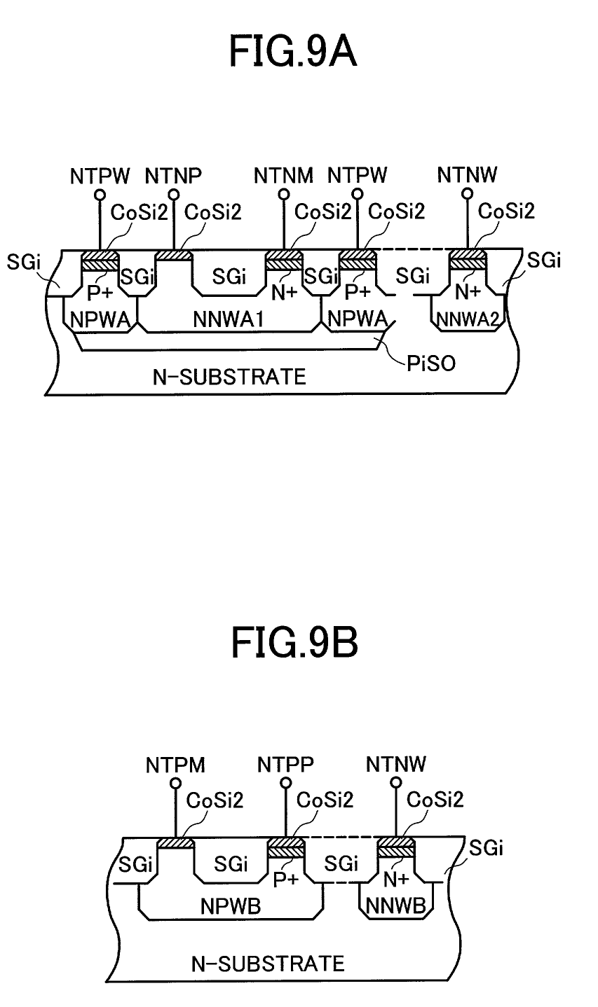

FIG. 9A and FIG. 9B show an example with the N-type substrate in use while FIG. 10A and FIG. 10B show an example with the SOI substrate in use. In FIG. 9A and FIG. 9B, NNWA1, NNWA2 and NNWB indicate N wells while NPWA and NPWB indicating P wells, and PiSo is a P-type semiconductor region to establish the electric potential of the N well separately from that of the N-type substrate. The same references are used for the structural parts having the same function as shown in FIGS. 2A and 2B.

Also in the N-type substrate, the Schottky diode is prepared just by the production process of the MOS transistor, wherein the NNWA1, NNWA2 and NNWB are prepared in the same step as for the N well as arranged in the PMOS transistor while the NPWA and NPWB are prepared in the same process as for the P well as arranged in the NMOS transistor.

In FIG. 9A, NTNP and NTNM indicate a terminal as connected to the Schottky contact portion of the Schottky diode and a terminal as connected to the ohmic contact portion thereof, wherein the electric potential of the NTNP corresponds to the metallic side potential of the Schottky contact while the electric potential of the NTNM corresponding to the semiconductor side potential thereof. In this constitution, the electric potential of the NTNP is arranged higher than that of the NTNM for the forward bias connection of the Schottky diode.

In the drawing, the arrangement of NNWA2, N+ and CoSi₂ in contact with the N+ is intended for setting the N-type substrate at a given electric potential by applying voltage to a terminal NTNW, to which terminal VCC voltage is applied, for instance. In order to prevent the NNWA1 from being simultaneously set at the electric potential of the N-type substrate, as shown in the drawing, the arrangement of NPWA, P+, CoSi₂ in contact with the P+ and PiSO is provided and a lower voltage is applied to the terminal NTPW than that applied to the NTNW so as to create a reverse bias condition against the P-N junction. To the terminal NTPW, grounding voltage is applied, for instance.

In FIG. 9B, NTPM and NTPP indicate a terminal as connected to the Schottky contact portion of the Schottky diode and a terminal as connected to the ohmic contact portion thereof, respectively, wherein the electric potential of the NTPM corresponds to the metallic side potential of the Schottky contact while that of the NTPP corresponding to the semiconductor side potential thereof. In this constitution, the electric potential of the NTPP is arranged higher than that of the NTPM for the forward bias connection of the Schottky diode. The arrangement of NNWB, N+ and CoSi₂ in contact with the N+ is intended for setting the N-type substrate at a given voltage by applying voltage to the terminal NTNW, to which terminal VCC voltage is applied, for instance.

In FIG. 10A and FIG. 10B, SNW indicates N well while SPW indicating P well. The same references are applied to the structural portions having the same function as shown in FIGS. 2A and 2B.

The formation of the Schottky diode in the SOI substrate is feasible in the same process as for the MOS transistor, wherein the SNW is formed in the same process as for the N well as arranged in the PMOS transistor while the SPW is formed in the same process as for the P well as arranged in the NMOS transistor.

In the SOI substrate, the respective devices are separated from the substrate through such dielectric film as oxide film so as to allow those devices to be separated from one another by etching operation, which permits independent devices to be formed without the use of SGi or NiSO and as such.

In FIG. 10A, STNP and STNM respectively indicate a terminal as connected to the Schottky contact portion of the Schottky diode and that as connected to the ohmic contact portion thereof, wherein the electrical potential of the STNP corresponds to the metallic side potential of the Schottky contact while that of the STNM corresponding to the semiconductor side potential thereof. In this example, the electric potential of the STNP is arranged higher than that of the STNM for the forward bias connection of the Schottky diode.

In FIG. 10B, STPM and STPP indicate respectively a terminal as connected to the Schottky contact portion of the Schottky diode and that as connected to the ohmic contact portion thereof, wherein the electric potential of the STPM corresponds to the metallic side potential of the Schottky contact while that of the STPP corresponding to the semiconductor side potential thereof. In this constitution, the electric potential of the STPP is arranged higher than that of the STPM for the forward bias connection of the Schottky diode.

Further, the flash memory production process is feasible to form the Schottky diode having the same arrangement as shown in FIGS. 2A and 2B, as the MOS transistor is formed therein in the same process as for CMOS.

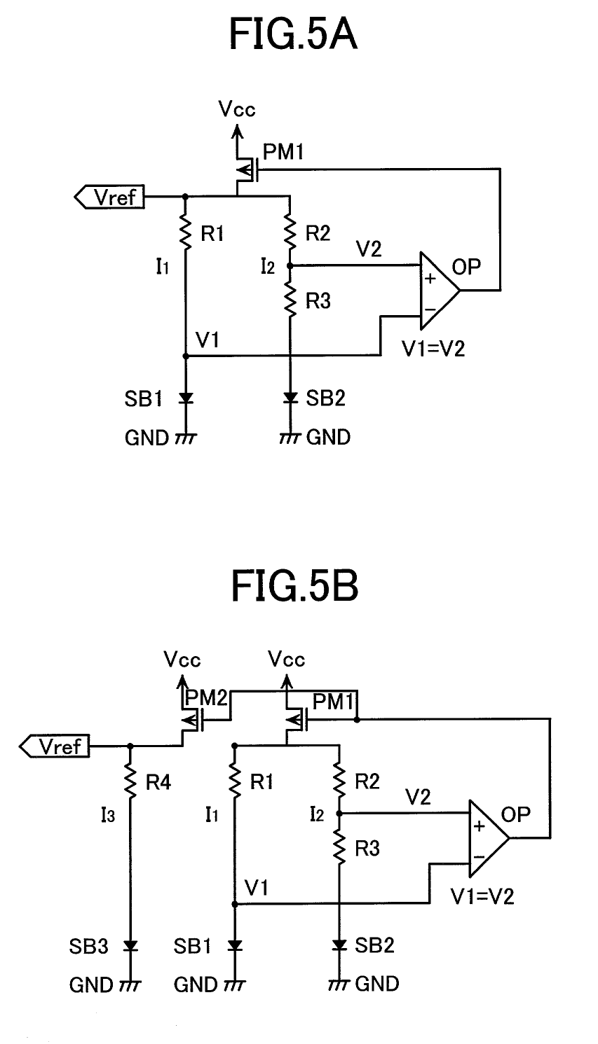

Then, the principle of the temperature compensation operation of a reference voltage generator according to the present invention is explained with a concrete example thereof exemplified in FIGS. 5A and 5B. FIG. 5A shows the basic arrangement of the reference voltage generator having temperature compensated function, and FIG. 5B shows the modified example thereof. To begin with, the basic arrangement thereof is explained with reference to FIG. 5A.

In the drawing, R1, R2 and R3 indicate resistors and PM1 indicates a PMOS transistor while OP signifies a differential amplifier and SB1 and SB2 suggest Schottky diodes. Vref, GND and VCC therein indicate a terminal to which reference voltage is outputted, that to which grounding voltage is applied and that to which VCC voltage is applied, respectively.

In FIG. 5A, the Schottky diodes are in forward bias connection, in which I₁ and I₂ respectively indicate electric current to conduct through R1 and R2, and V1 signifies the electrical potential of a node to connect R1 with SB1 while V2 indicating that of a node to connect R2 with R3. Hereinafter, the resistance of the respective resistors R1, R2 and R3 is expressed with R1, R2 and R3. The differential amplifier OP is arranged such that it is connected to V1 and V2 for input while for output being connected to the PM1 gate, which operates so as to set the V1 and V2 at the same electric potential through feedback control. The OP operates under the supply voltage or the supply of the VCC voltage and the grounding voltage, for instance, which is not shown in the drawing.

For example, the OP may be arranged by connecting the PMOS transistors PMA0, PMA1 and PMA2 with the NMOS transistors NMA1 and NMA2, which arrangement is shown in FIG. 7A.

The input voltage to the differential amplifier comes from Va and Vb in the drawing, which voltage is applied to the PMA1 and PMA2 gates while the voltage as input thereto is output to the terminal Vout. The PMA0 operates to contract the electric current in flow so as to enhance its amplitude.

Likewise, the OP may be arranged by connecting the PMOS transistors PMB1 and PMB2 with the NMOS transistors NMB0, NMB1 and NMB2, as shown in FIG. 7B. The incoming voltage to the differential amplifier comes from Va and Vb in the drawing, which voltage is applied to the NMB1 and NMB2 gates respectively while the outgoing voltage is output to the terminal Vout. The NMB0 operates to contract the electric current in flow so as to enhance its amplitude.

The OP as mentioned above being put to use for the arrangement as shown in FIGS. 5A and 5B, it is arranged such that the V1 and V2 of the drawing correspond to the Va and Vb of FIGS. 7A and 7B and the terminal Vout is connected to the PM1 gate. Which is preferable for the arrangement of the OP to use either FIG. 7A or FIG. 7B depends on the VCC value, the threshold values of the PMOS and NMOS transistors and the Schottky diode operation point and so forth.

The characteristics of the Schottky diode that is prerequisite for temperature compensated function is described below. Generally, the electric current vs. voltage characteristics of the Schottky diode is expressed with the following equation (1), which equation is disclosed in the afore-mentioned D1 of equation (7-15) at page 107.

$$J n = A * {T}^{2} exp ( \frac{- q {Φ}_{B N}}{k T} ) \{ exp ( \frac{q {V}_{F}}{k T} ) - 1 \} \qquad ( 1 )$$

The Jn, A*, T, q, ø_{BN}, k and V_{F} of the equation stands for forward bias current density, Rechardson constant, absolute temperature, charge of the carrier, level of Schottky Barrier Potential, Bolzman constant and forward bias voltage as applied to the Schottky diode, respectively. The A* of an N-type silicon is equivalent to 2.28×10⁵.

Based on the fact that KT/q is equivalent to 0.026V under the condition of T=300K and providing that V_{F} is larger than 0.1V, exp (qV_{F}/kT) is found to be larger than 1. Namely, the term of −1 of the equation (1) is disregarded, which equation is expressed with the following equation (2) by rewriting the same such that the value of the V_{F} is solved.

$${V}_{F} = {Φ}_{B N} - \frac{k T}{q} I n ( \frac{A * {T}^{2}}{J n} ) \qquad ( 2 )$$

Under the normal semiconductor operation condition, 1n(A*T²/Jₙ) of the equation (2) is larger than 0. For example, provided that T is equal to 300K and Jₙ is in the order of 2×10⁶A/m², A*T²/Jₙ is in the order of 10⁴. That is, the value of the V_{F} is found to have the negative temperature characteristics.

Accordingly, the application of the voltage having the positive temperature characteristics within an appropriate range of value to the forward bias voltage allows a reference voltage generator having temperature compensated function to be arranged.

In FIG. 5A, providing that the area of the Schottky contact interface of the SB1 is represented with S1 while that of the SB2 being with S2 and the voltage of a higher potential side terminal of the SB1 is V_{F1} (equal to V1) while that of the SB2 is V_{F2}, and based on the fact that one ends of the R1 and R2 are in connection while the other ends thereof are set at the same potential through the differential amplifier OP, the following equation (3) results,

I₁×R1=I₂×R2 (3)

which also brings the following equation (4).

I₁/I₂=R2/R1 (4)

In other words, it is arranged such that the electric current (I₂) flowing through the second Schottky diode as shown in FIG. 5A keeps a given rate against that (I₁) of the first Schottky diode.

Further, given that the forward bias current density of the SB1 is J₁ while that of the SB2 is J₂, the values thereof are obtained by the following equations (5) and (6).

J₁=I₁/S1 (5)

J₂=I₂/S2 (6)

The following equation (7) results from those equations (4), (5) and (6).

$${J}_{1} / {J}_{2} = \frac{R2S2}{R1S1} \qquad ( 7 )$$

Accordingly, the use of the equation (2) results in the following equation (8).

$$\begin{matrix}{I}_{2} = ( V2 - {V}_{F2} ) / R3 \\ = ( V1 - {V}_{F2} ) / R3 \\ = ( {V}_{F1} - {V}_{F2} ) / R3 \\ = \frac{k T}{q} \frac{I n ( {J}_{1} / {J}_{2} )}{R3} \\ = \frac{k T}{q} \frac{I n ( \frac{R2S2}{R1S1} )}{R3}\end{matrix} \qquad ( 8 )$$

The following equation (9) results therefrom.

$$\begin{matrix}Vref = {V}_{F1} + {I}_{1} R1 = {V}_{F1} + {I}_{2} R2 \\ = {Φ}_{B N} - ( \frac{k T}{q} ) I n ( A * {T}^{2} / {J}_{1} ) + \\ \frac{k T}{q} \frac{R2}{R3} I n ( \frac{R2S2}{R1S1} )\end{matrix} \qquad ( 9 )$$

In view of the fact that the second term and the third term (temperature compensation voltage; V_{T}) of the equation (9) have the reverse characteristics to the temperature, provided that the values of R1, R2 and R3 as well as S1 and S2 are given in a proper manner, the value of the logarithmic function 1n (A*T²/J₁) of the second term thereof changes according to the variable T, but the degree to which the value changes is disregarded in comparison with the coefficient kT/q and Vref outputs the temperature compensated voltage as affected by the change of the ambient temperature in the least degree, as the second and third terms thereof set off the mutual characteristics against the temperature change.

Given that the forward bias voltage of the first Schottky diode (SB₁) and that of the second Schottky diode (SB₂) among the plurality of Schottky diodes of the reference voltage generator as shown in FIG. 5A are represented with V_{F1} and V_{F2}, respectively, the output voltage (Vref) as expressed in the equation (9) or the voltage as affected by the change of the ambient temperature in the least degree is expressed as A·V_{F1}+B·(V_{F1}−V_{F2}) by using constants A and B. Further, those constants A and B are arranged such that the output voltage decreases against the increased temperature, the value of which constant A is equivalent to 1.

In other words, it is arranged such that the change due to the ambient temperature of the forward bias voltage of any one (the first Schottky diode, for instance) of the plural Schottky diodes (the first and second Schottky diodes) is compensated by the difference in forward bias voltage between the plural Schottky diodes.

There is no term regarding the supply voltage VCC in the equation (9) so that the output voltage Vref is stable against the fluctuation of the VCC, provided that the VCC has a capacity enough to operate the reference voltage generator.

Hereinafter, the setting of the values of R1, R2 and R3 as well as those of S1 and S2 is exemplified. The operation condition is defined by setting the ratio of R1 to R2, the values of S1 and S2 as well as that of I₁ under the condition of T=300K in an arbitrary manner, in accordance with which the other values are also determined. One example is exemplified on the assumption that R1 is equal to R2 and S1 is equivalent to 0.50 μm² while S2 is equivalent to 5 μm² as well as I₁ is equivalent to 1 μA under the condition of T=300K.

Then, the equation (9) is expressed as the following equation (10).

$$\begin{matrix}Vref = {Φ}_{B N} - \frac{k T}{q} I n ( A * {T}^{2} / {J}_{1} ) + \\ \frac{k T}{q} \frac{R2}{R3} I n ( 10 )\end{matrix} \qquad ( 10 )$$

The T and J₁ of the logarithmic function are subject to the temperature change, but they may be approximated in quantity so as to be represented with appropriate values to an extent that the temperature is compensated, which allows a sufficient temperature compensation effect to be obtained. Accordingly, T being represented with 300K, for instance, the following equation (11) results from the following equation (32).

J₁=I₁/S1=2×10⁶(A/m²) (32)

$$\begin{matrix}Vref = {Φ}_{B N} - ( \frac{k T}{q} ) I n ( \frac{2.28 \times {10}^{5} \times {300}^{2}}{2 \times {10}^{6}} ) + \\ \frac{k T}{q} \frac{R2}{R3} I n ( 10 )\end{matrix} \qquad ( 11 )$$

Then, in order to realize the temperature compensated function, the second and third terms of the equation (11) must be equated, which results in the following equation (12).

$$I n ( \frac{2.28 \times {10}^{5} \times {300}^{2}}{2 \times {10}^{6}} ) = \frac{R2}{R3} I n ( 10 ) \qquad ( 12 )$$

That is, in order to equate the left and right sides of the equation (12), the R2/R3 thereof is set as shown in the following equation (13).

$$\frac{R2}{R3} = 4.01 \qquad ( 13 )$$

Based on the fact that I₁ and I₂ are equal to 1 μA under the condition of T=300K, the respective values being allotted into the equation (8), this results in the following equation (14).

R3=59.5 k ohm (14)

Accordingly, the following equation (15) results from the above equation (13).

R1=R2=239 k ohm (15)

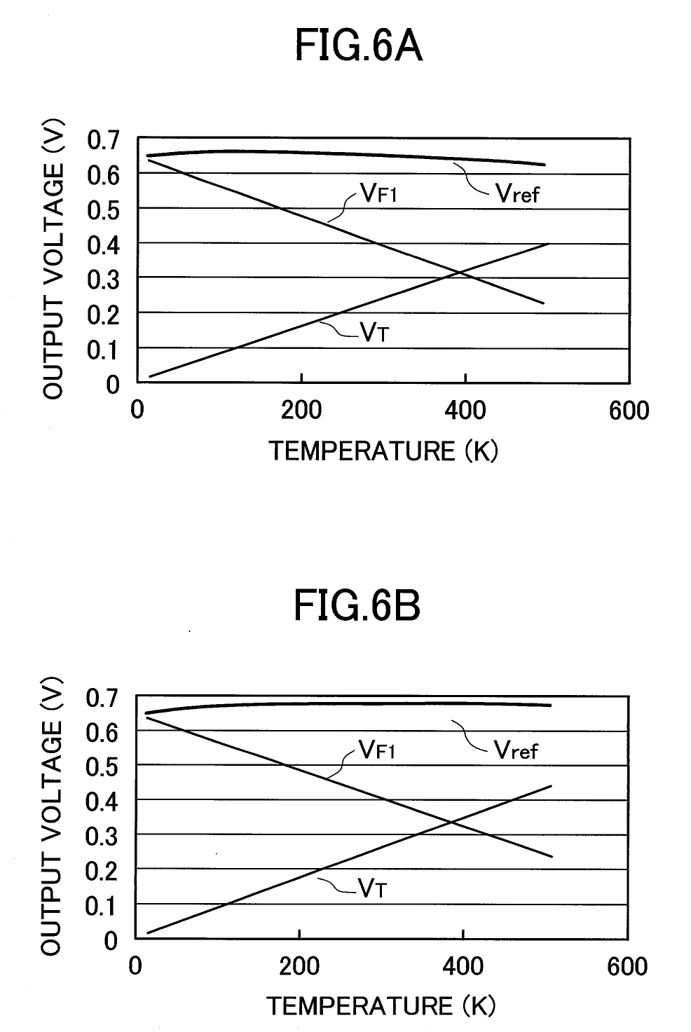

FIG. 6A shows the state where the Vref changes according to the increased temperature. As shown in the drawing, the voltage of the afore-mentioned V_{F1} and V_{T} respectively increases or decreases in proportion to the ambient temperature so as to be set off against each other, which results in the characteristics of the output voltage (Vref). The V_{T} is the voltage proportionate to the difference in the forward bias voltage between two Schottky diodes and corresponds to the third term of the equations (9) or (11).

The value of the Vref is equivalent to 654 mV, 650 mV and 646 mV under the condition of T=250K, 300K and 350K, respectively. There is another method to determine the constants in order to realize the temperature compensation, wherein the respective values are determined such that the coefficient Vref′ as obtained by differentiating Vref by temperature results in 0 under the condition of T=300K that falls within the range of the temperature compensation, for instance.

Then, the following equation (16) results from the equation (9).

$$\begin{matrix}\frac{q}{k} {Vref}^{′} = - I n ( A * {T}^{2} / {J}_{1} ) - \\ T {\{ I n ( A * {T}^{2} / {J}_{1} ) \}}^{′} + \frac{R2}{R3} I n ( \frac{R2S2}{R1S1} ) \\ = - I n ( A * {T}^{2} / {J}_{1} ) - \\ {T ( A * {T}^{2} / {J}_{1} )}^{′} + \frac{{J}_{1}}{A * {T}^{2}} + \\ \frac{R2}{R3} I n ( \frac{R2S2}{R1S1} ) \\ = - I n ( A * {T}^{2} / {J}_{1} ) - \\ \frac{{J}_{1}}{A * {T}^{2}} ( 2 \frac{A * T}{{J}_{1}} - {J}_{1}^{′} \frac{A * {T}^{2}}{{J}_{1}^{2}} ) + \\ \frac{R2}{R3} I n ( \frac{R2S2}{R1S1} ) \\ = - I n ( A * {T}^{2} / {J}_{1} ) - \\ ( 2 - T \frac{{J}_{1}^{′}}{{J}_{1}} ) + \frac{R2}{R3} I n ( \frac{R2S2}{R1S1} )\end{matrix} \qquad ( 16 )$$

The following equation (17) results therefrom and the I₂ thereof is proportionate to T, which results in the equation (18).

J₁=I₁/S1=I₂/S1 (17)

J₁′/J₁=1/T (18)

Accordingly, the equation (16) results in the following equation (19).

$$\begin{matrix}\frac{q}{k} {Vref}^{ ′} = - In ( A * {T}^{2} / {J}_{1} ) - \\ ( 2 - T \frac{1}{T} ) + \frac{R2}{R3} I n ( \frac{R2S2}{R1S1} ) \\ = - In ( A * {T}^{2} / {J}_{1} ) - \\ 1 + \frac{R2}{R3} I n ( \frac{R2S2}{R1S1} )\end{matrix} \qquad ( 19 )$$

Then, on the assumption that R1 is equal to R2, and S1 is equivalent to 0.50 μm² while S2 is equivalent to 5 μm² as well as I₁ is equivalent to 1 μA under the condition of T=300K, in order to make the Vref′ zero under the condition of T=300K, the allotment of the respective values into the equation (19) results in the R2/R3 thereof being set at shown in the following equation (20).

R2/R3=4.45 (20)

Further, based on the fact that I₁ and I₂ are equivalent to 1 μA, the respective values being allotted into the equation (8), which results in the following equation (21).

R3=59.5 k ohm (21)

Accordingly, the following equation (22) results from the above equations.

R1=R2=265 k ohm (22)

FIG. 6B shows the state where the Vref changes according to the increased temperature. The characteristic of the voltage of the V_{F1} and V_{T} VS. the ambient temperature as shown is the same as that as shown in FIG. 6A. The value of the Vref amounts to 676 mV at any temperatures of 250K, 300K and 350K.

In the present embodiment, it is indeed that the setting of the values of the resistors R1, R2 and R3 as well as those of the areas S1 and S2 of the Schottky contact interfaces of the Schottky diodes SB1 and SB2 is essential for realizing the temperature compensated function, which setting is not limited to the above values, but may be modified within the scope and spirits of the present invention according to the operation condition and the precision as required.

Further, the arrangement of the reference voltage generator is not limited to that as shown in FIG. 5A, which generator may be arranged such that the voltage proportionate to the forward bias voltage of one Schottky diode and that proportionate to the difference in forward bias voltage between two Schottky diodes, the ratio of the current density of one of which diodes to that of the other is kept constant, are added so as to be output, wherein the temperature compensation operation thereof is carried out according to the precision as required by adjusting the values of the resistors incorporated therein. This includes a method, wherein the positive electrodes of two Schottky diodes are connected to VCC terminals while the negative ones thereof are connected to the resistors.

Moreover, as shown in FIG. 5B, which is a modified example of the arrangement as shown in FIG. 5A, another method is feasible, wherein with three or more Schottky diodes in use the difference in forward bias voltage between the first and second diodes thereof compensates the temperature dependency of the forward bias voltage of the third diode thereof.

In other words, it may be arranged such that the change as caused by the ambient temperature of the forward bias voltage of any one (the third Schottky diode, for instance) of the plural Schottky diodes (comprising the first to third Schottky diodes) is compensated with the difference in forward bias voltage between the plural Schottky diodes (between the first and second Schottky diodes, for instance).

In the reference voltage generator as shown in FIG. 5B, the above compensation method is expressed as follows, in which R1 to R4 indicate resistors, and PM1 as well as PM2 indicate PMOS transistors while OP stands for a differential amplifier, and SB1 to SB3 indicate Schottky diodes, and Vref is a terminal from which reference voltage is output, and GND is a terminal to which grounding voltage is applied, and VCC is a terminal to which VCC voltage is applied.

The Vref is expressed as the following equation (23).

$$\begin{matrix}Vref = {V}_{F3} + {I}_{3} \times R4 \\ = {V}_{F3} + ( {I}_{1} + {I}_{2} ) \times R4\end{matrix} \qquad ( 23 )$$

Where R1 is equal to R2, the I₁ results in being equal to the I₂. This results in the following equation (24).

Vref=V_{F3}+2×I₂×R4 (24)

Further, the following equation (25) results from the afore-mentioned equation (8).

I₂=(V_{F1}-V_{F2})/R3 (25)

This results in the following equation (26).

Vref=V_{F3}+2×R4×(V_{F1}-V_{F2})/R3 (26)

Where the value of R1 is different from that of R2, it results in the following equations (27) and (28).

I₁=(R2/R1)×I₂ (27)

$$\begin{matrix}{I}_{3} = {I}_{1} + {I}_{2} \\ = ( 1 + R2 / R1 ) \times {I}_{2}\end{matrix} \qquad ( 28 )$$

It is arranged herein that the ratio of the electric current (I₂) flowing through the second Schottky diode to that (I₃) flowing through the third Schottky diode is kept constant. This results in the following equation (29) that further results in the following equation (30) with the equation (25) taken into account.

$$\begin{matrix}Vref = {V}_{F3} + {I}_{3} \times R4 \\ = {V}_{F3} + ( 1 + R2 / R1 ) \times {I}_{2} \times R4\end{matrix} \qquad ( 29 )$$

Vref=V_{F3}+(1+R2/R1) (R4×(V_{F1}-V_{F2})/R3) (30)

The above equations (26) and (30) express the method, wherein the temperature dependency of the forward bias voltage of the third Schottky diode is compensated with the difference in the forward bias voltage between the first and second Schottky diodes.

In other words, on the assumption that the forward bias voltage of the first Schottky diode (SB₁) is V_{F1} and that of the second Schottky diode (SB₂) is V_{F2} while that of the third Schottky diode (SB₃) is V_{F3}, the voltage as affected by the change of the ambient temperature in the least degree is expressed as A·V_{F3}+B·(V_{F1}-V_{F2}) by using constants A and B. Those constants are arranged such that the output voltage decreases against the increased temperature, and the constant A is equivalent to 1.

Further, the application of the arrangement of the conventional band-gap reference voltage generator as disclosed in the Japanese Patent Application Laid-open No. H11-45125, for instance, allows the same generator to operate under a far lower supply voltage VCC, which does not deviate from the scope and spirits of the present invention.

In this case, the reference voltage generator is arranged such that it outputs the voltage proportionate to the electric current as obtained by adding the electric current proportionate to the forward bias voltage of one Schottky diode to that proportionate to the difference in forward bias voltage between two Schottky diodes, the ratio of the current density of one of which diodes to that of the other is kept constant. The conversion of the voltage into the current proportionate thereto and vice versus is performed by means of appropriate resistors.

The temperature compensation is feasible by rewriting the forward bias voltage of the respective diodes by the equation (2) and representing the value of T with 300K so as to set respective resistance values such that the temperature characteristic is counterbalanced.

Then, the utilization of the reference voltage generator according to the present invention is exemplified. FIG. 8 shows a method to shift the voltage Vref as output from the generator as shown in FIG. 5A and FIG. 5B and to generate a higher reference voltage Vref2. In the drawing, the generator indicates the arrangements as shown in FIG. 5A and FIG. 5B, and R21 and R22 stand for resistors while OP2 indicating an operational amplifier. In this arrangement, the feedback control by the operational amplifier results in a new reference voltage or Vref2 being output, which Vref2 is expressed as in the following equation (31).

$$Vref2 = \frac{R21 + R22}{R22} Vref \qquad ( 31 )$$

The operational amplifier OP2 operates under the supply of the VCC and the grounding voltage, for instance. On the other hand, a new reference voltage lower than Vref is generated by means of resistance split, for example. That is, once the stable reference voltage Vref is generated, an arbitrary reference voltage is available on the basis of the Vref.

The reference voltage generator according to the present invention is formed on the same semiconductor substrate together with any one of a MOS transistor switch, a Phase-locked loop (PLL), a substrate bias voltage control circuit (active VBB), a delayed locked loop (DLL). The reference voltage as generated from the same generator is available for a MOS transistor switch, a Phase-locked loop, a substrate bias voltage control circuit, and a delayed locked loop.

In other words, the above reference voltage that is generated by the voltage generator and affected by the change of the ambient temperature in the least degree is used for controlling any one of the MOS transistor switch, the Phase-locked loop, the delayed locked loop, the substrate bias voltage control circuit and so forth.

The PLL compares the signal as output from the oscillator integrated therein with that as input thereto so as to detect errors in frequency and phase for the feedback operation to the oscillator and to output a signal without deviating from the frequency and phase of the signal as input thereto.

The DLL outputs a signal without deviating from the phase of the signal as input thereto through a synchronizing loop by means of a delay device. The MOS transistor switch is such as disclosed in K.Itoh et al., Proc. IEEE, pp.524-439, 1995, which switch is inserted between the power source and the circuit while the active VBB is a device as introduced in the lecture No.WP25.6 of 2000 IEEE International Solid-State Circuit Conference.

Further, the reference voltage generator according to the present invention is prepared only through the CMOS process, so that the preparation of the library forming the intellectual property core for the ASIC design, for instance, allows the same generator to be used in the variety of circuit arrangements. The intellectual property (IP) corresponds to the property such as the LSI system design. More concretely, the intellectual property (IP), for instance, is intended for facilitating the system design of the LSI by means of the reuse of various functional blocks or packaging the functional blocks supplied from different sources under the standardized specification.

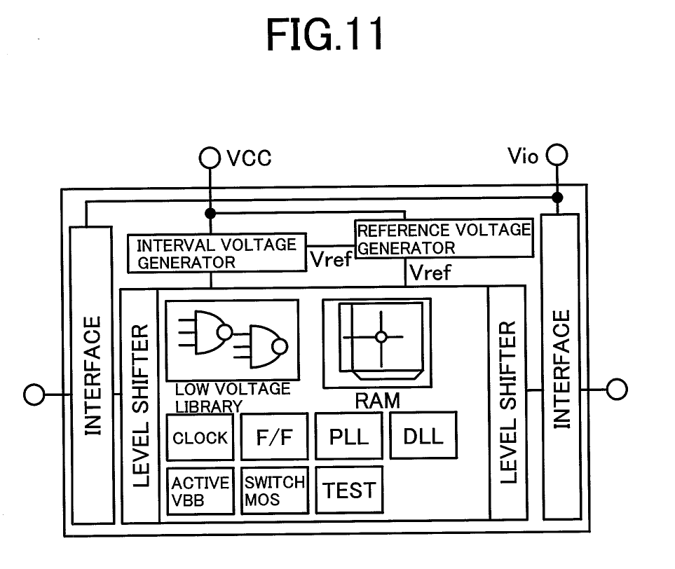

FIG. 11 shows an example, wherein the reference voltage generator according to the present invention is utilized in the LSI circuit (IP core) in which the variety of devices are integrated. In this example, the reference voltage generator, to which the supply voltage VCC is applied, outputs a reference voltage for the internal voltage generator and the other devices.

The Vio in the drawing indicates an I/O voltage, the arrangement of the subject LSI may be such that the voltage of both VCC and Vio is of one V or less. The low voltage library therein indicates the variety of devices that operate under a lower supply voltage, and RAM is a memory region composed of such non-volatile memory as SRAM, DRAM or flash memory, and F/F indicates a flip flop circuit while test indicating a circuit for controlling self-testing.

The level shifter is a circuit such as disclosed in ‘Symp. on VLSI Circuits Tech. Digest, 2000, pp. 202-203’, for instance. The above LSI, for instance, is used for a part of the devices comprising a portable phone.

As described above, the reference voltage generator according to the present invention allows the temperature compensated reference voltage to be generated under the supply voltage of 1V or less.

Therefore, the supply voltage of the LSI becomes much lower.

What is claimed is:

1. A reference voltage generator comprising a plurality of Schottky diodes, wherein said generator outputs a voltage that is affected by an ambient temperature change in the least degree.

2. A reference voltage generator according to claim 1, wherein said generator is arranged such that a change as caused by the ambient temperature of a forward bias voltage for any one of said plurality of Schottky diodes is compensated with a difference in the forward bias voltage in said plurality of Schottky diodes.

3. A reference voltage generator according to claim 1, wherein when a forward bias voltage of a first Schottky diode is V_{F1} and a forward bias voltage of a second Schottky diode is V_{F2} in said plurality of Schottky diodes, the voltage that is affected by the ambient temperature change in the least degree is represented as A*V_{F1}+B*(V_{F1}-V_{F2}) by using constant A and B.

4. A reference voltage generator according to claim 2, wherein said any one of said plurality of Schottky diodes corresponds to a third Schottky diode while the difference in the forward bias voltage between said plurality of Schottky diodes is represented by the difference in the forward bias voltage between the first and second Schottky diodes.

5. A reference voltage generator according to claim 1, wherein when a forward bias voltage of a first Schottky diode is V_{F1}, a forward bias voltage of a second Schottky diode is V_{F2}, and a forward bias voltage of a third Schottky diode is V_{F3} in said plurality of Schottky diodes, the voltage that is affected by the ambient temperature change in the least degree is represented as A*V_{F3}+B*(V_{F1}-V_{F2}) by using constant A and B.

6. A reference voltage generator according to claim 4, wherein it is arranged such that a ratio of an electric current flowing through said second Schottky diode to an electric current flowing through said third Schottky diode is kept constant.

7. A reference voltage generator according to claim 3, wherein it is arranged such that a ratio of an electric current flowing through said second Schottky diode to an electric current flowing through said first Schottky diode is kept constant.

8. A reference voltage generator according to claim 3, wherein said constant A and B are set such that an output voltage decreases against an increased temperature and said constant A is equivalent to 1.

9. A reference voltage generator according to claim 1, wherein a differential amplifier is provided therein.

10. A reference voltage generator according to claim 1, wherein a voltage as output from said generator is subject to a level shifting so as to output a reference voltage, in which an operational amplifier is utilized for said level shifting.

11. A reference voltage generator according to claim 1, wherein a semiconductor region constructing a Schottky contact interface of one of said Schottky diodes is formed in the same process as for a dopant implantation to an N well region constructing a channel region of a PMOS transistor, in which said transistor is formed on the same semiconductor substrate as a semiconductor substrate on which said one of said Schottky diodes is formed.

12. A reference voltage generator according to claim 1, wherein a semiconductor region constructing a Schottky contact interface of one of said Schottky diodes is formed in the same process as for an acceptor implantation to a P well constructing a channel region of an NMOS transistor, in which said transistor is formed on the same semiconductor substrate as a semiconductor substrate on which said one of said Schottky diodes is formed.

13. A reference voltage generator according to claim 11, wherein a metallic region constructing the Schottky contact interface of said one of said Schottky diodes is made from silicide material.

14. A reference voltage generator according to claim 11, wherein a metallic region constructing the Schottky contact interface of said one of said Schottky diodes is formed in the same process as for a formation of the metallic region constructing a contact region of a MOS transistor, in which said MOS transistor is formed on the same semiconductor substrate as a semiconductor substrate on which said one of said Schottky diodes is formed.

15. A reference voltage generator according to claim 11, wherein said semiconductor substrate is constructed from any one of a P-type semiconductor substrate, an N-type semiconductor substrate or an SOI substrate, in which a memory cell of a flash memory is formed on said semiconductor substrate.

16. A reference voltage generator according to claim 1, wherein an output voltage that is affected by the ambient temperature change in the least degree is used for controlling any one of a switch MOS transistor, a Phase-locked loop circuit, a substrate bias voltage control circuit and a delayed locked loop circuit.

17. A reference voltage generator according to claim 16, wherein said generator is formed on the same semiconductor substrate together with any one of said Phase-locked loop circuit, said substrate bias voltage control circuit and said delayed locked loop circuit.

18. An IP core having a reference voltage generator including a plurality of Schottky diodes, wherein a change as caused by an ambient temperature of a forward bias voltage of any one of said Schottky diodes is compensated with a difference in the forward bias voltage between said plurality of Schottky diodes.

19. A reference voltage generator comprising a plurality of rectifiers, wherein a change as caused by an ambient temperature of a forward bias voltage of any one of said rectifiers is compensated by using the forward bias voltage of the other of said rectifiers, wherein a reference voltage that is less than or equal to 0.7V is generated for output under a power supply voltage that is less than or equal to 1V.
